(19) United States
(12) Patent Application Publication
(10) Pub. No.: US 2018/0177679 A1
(43) Pub. Date: Jun. 28, 2018

(54) METHODS AND SYSTEMS FOR MOBILE CPR ASSISTANCE

(71) Applicant: University of North Texas, Denton, TX (US)

(72) Inventors: Ramanamurthy Dantu, Richardson, TX (US); Hakiza Theogene Bucuti, Denton, TX (US)

(21) Appl. No.: 15/809,485

(22) Filed: Nov. 10, 2017

Related U.S. Application Data
(60) Provisional application No. 62/420,888, filed on Nov. 11, 2016.

(51) Int. Cl. A61H 31/00

(52) U.S. Cl. CPC A61H 31/005; A61H 2201/5084; A61H 2201/5007; A61H 2201/5048; A61H 2201/5097

(57) ABSTRACT

Methods and systems for providing monitoring and real-time feedback of CPR administration include a mobile device software application. The application is implemented on at least two mobile devices, one affixed to the wrist of at least one user and one used as a display device. The application utilizes data recorded by the accelerometer of the mobile device affixed to the wrist of the user and provides data and recommendations relating to chest compression rate and chest compression depth.

This application claims priority to U.S. Provisional Patent Application No. 62/420,888, entitled “Methods and Systems for Mobile CPR Assistance,” filed Nov. 11, 2016, the entire contents of which are hereby incorporated by reference.

### BACKGROUND

This disclosure pertains to methods and systems for providing real-time feedback to an individual during CPR administration using a mobile device software application.

Timely performance of high quality cardio-pulmonary resuscitation (CPR) is a key determinant of survival from cardiac arrest. Prompt administration of chest compressions, adequate depth, rate and minimizing pauses are strongly correlated to return of spontaneous circulation and survival with variability in CPR performance likely accounts for regional differences in cardiac arrest outcomes. Current guidelines emphasize minimal interruption, adequate compression depth and rate, and complete chest recoil during CPR as essential characteristics of high-quality CPR.

One of the many challenges in delivering effective CPR is ensuring adequate provider training and skill retention. Studies of simulated clinical trials have shown that the retention of resuscitation skills is low even among trained healthcare professionals; a result of either inefficient training or as often observed, a deterioration of acquired skills due to nonuse over time. The American Heart Association has emphasized poor quality CPR as a “preventable harm” and has stressed improved training, skill retention, monitoring and feedback as important performance metrics. This Resuscitation Quality Improvement (RQI) program has led to the development of a number of innovative solutions including automated voice-assisted manikins to facilitate self-directed continuous practice of CPR skills to address these gaps in CPR performance. The technology consists of mobile simulation stations (manikins and connected computers) equipped with cognitive learning modules, allowing trainees to be assessed on cognitive and psychomotor skills activities through its patient cases simulations. The program's objective is to use automated feedback to provide a high-quality debriefing in order to facilitate continuous self-directed practice of life support skills thus helping participants achieve and retain competency in resuscitation skills with a goal to improve their effectiveness during resuscitation events.

Quality of bystander performed CPR can be even more variable from lack of regular training to hesitancy in “doing the wrong thing.” The number of cardiac arrest victims receiving potentially lifesaving CPR from lay bystanders is still lower than it should be, indicating some effort for integration is still required to involve non-professionals in providing adequate care when needed.

An ideal solution, applicable to both the layperson and healthcare professional would be to provide point of care real-time feedback on CPR quality. Prior studies of such systems have been limited to health care providers, either inpatient or emergency responders, but have shown improved CPR metrics with regards to compression rate and target depths achieved. While these systems provide essential point of care information, the cost and exclusivity of such systems limits the potential availability to mainly health care settings in developed countries. A scalable and low cost system with similar ability deliver real-time monitoring of adequate compression depth, frequency and recoil in addition to “hands-off” time could allow for rapid and wide-spread adoption amongst resource limited health systems as well as the general public.

Current devices can generally be sub-divided into two categories, those that monitor compression quality and those that rely on physiologic (e.g. end-tidal CO₂, cerebral perfusion) end-points to guide CPR. Devices monitoring CPR compression quality range from simple metronomes to more complex devices that measure compression depth using either accelerometers or pressure/resistance springs. To date, two such devices have been tested clinically in randomized trials. One is a hand-sized non-electronic, compression spring based system that is applied to the center of the chest. In a study of 80 ICU patients, those randomized to the device had a nearly twofold higher increase in return of spontaneous circulation (72% vs 35%) and fewer instances of rib fracture (57% vs 85%) compared to standard care. A larger randomized study of out of hospital cardiac arrests tested the Q-PCR (Philips Medical System), a “puck” sized device with an accelerometer placed on the patient's chest providing both audio and visual feedback on a small display on the device. Emergency medical personnel were randomized to clusters with the Q-PCR system and performed CPR in nearly 1600 out of hospital arrests. Patients who received device guided CPR were more likely to have increased depth of compression (38 vs 40 mm) and decreased likelihood of incomplete recoil. There were no differences in return of spontaneous circulation nor survival to discharge. Of note, audio prompts were muted in 14% of events and average compression depths were below current recommended guidelines (50-60 mm) potentially explaining the null result with regards to patient outcomes. Similar studies utilizing sensors placed in defibrillator pads have had similarly minimal to null results but have also been confounded by adherence to older guidelines for compression depth (38-50 mm).

### SUMMARY

The present disclosure relates generally to methods and systems for providing remote and mobile assistance in the performance of CPR. In specific embodiments, a wearable mobile based CPR feedback system is used to facilitate training and also assist caregivers in providing high-quality CPR. The system leverages accelerometers present in ubiquitous mobile devices (smartphones or wearables such as smart watches) to collect quantitative metrics to assess the compliance of the chest compressions and offer real-time feedback to help deliver effective CPR. The affordability of the devices and their portability are a convenience for both lay bystanders and trained professionals, offering a reasonable solution to ensuring effective CPR with the ultimate goal of improving outcomes from cardiac arrest.

### BRIEF DESCRIPTION OF THE DRAWINGS

FIG. 1 shows (A) a setup for wearing an exemplary smart watch and smart phone and (B) a screen from a software application providing feedback as to CPR administration, in accordance with exemplary embodiments.

FIG. 2 shows a high-level flow chart for events and steps in the CPR analysis performed by the mobile device software application.

FIG. 3 shows sensor data processing procedures in obtaining linear acceleration along the vertical axis.

FIG. 4 shows steps for position estimation using linear acceleration.

FIG. 5 shows pre-processing steps in extracting an estimation of linear acceleration from a raw accelerometer reading.

FIG. 6 shows a state machines for detection of CPR pumps.

FIG. 7 shows a framework for compression sequence analysis and feedback generation.

FIG. 8 shows steps in a sequence analyzer of compression sequences.

FIG. 9 shows steps in feedback generation.

FIG. 10 shows steps in a process of alignment of video and phone recorded CPR pumps.

FIG. 11 shows a feedback analysis plot in a timeline of CPR pumps and prompt delivery during a CPR session.

FIG. 12 shows a summary of steps and interfaces on a CPR client device.

FIG. 13 shows a summary of steps and interfaces on a CPR monitor device.

FIG. 14 shows Bland-Altman plots comparing compression depth between an exemplary smart-watch (A) and smart-phone (B) and calibrated manikin.

FIG. 15 shows a comparison of compression rate between exemplary mobile devices and QCPR manikin.

FIG. 16 shows examples of CPR application feedback prompts and subsequent CPR improvement in terms of compression depth.

FIG. 17 shows number of prompts received by users.

FIG. 18 shows screens from a software application providing CPR session review, in accordance with exemplary embodiments.

FIG. 19 shows a screen shot of a navigation screen of a preferred embodiment of a mobile device software application.

FIG. 20 shows a screen shot of a screen providing visual feedback to a user of a preferred embodiment of a mobile device software application during CPR.

FIG. 21 shows a screen shot of an ‘Android CPR Service’ application in a preferred embodiment of this disclosure.

FIG. 22 shows a screen shot of a remote monitoring dashboard in a preferred embodiment of this disclosure.

FIG. 23 shows a screen shot of a session review feature in a preferred embodiment of this disclosure.

FIG. 24 shows a screen shot of a pump review feature in a preferred embodiment of this disclosure.

FIG. 25 shows a screen shot of a position review feature in a preferred embodiment of this disclosure.

### DETAILED DESCRIPTION OF PREFERRED EMBODIMENTS

Generally, the present disclosure relates to providing mobile assistance in the administration of CPR and preferably to a software program for mobile devices that provides real-time feedback as to compression rate and depth.

Preferred embodiments of the present disclosure relate to methods for monitoring the administration of CPR using a mobile device, such as a smart watch or a smart phone. In additional preferred embodiments, the method includes using a smart phone for monitoring CPR administration when that phone has been constrained to an armband. In additional preferred embodiments, the smart phone may be tied to the arm with any suitable item such as a paper bag or a cloth. In certain additional preferred embodiments, the smart phone may be constrained on a shirt that is worn by the CPR administrator, including long sleeved or short sleeved shirts. In preferred embodiments, the CPR administrator wears the watch or phone and the start and stop of collection and transmission of measurements relating to the CPR administration is controlled by a remote device.

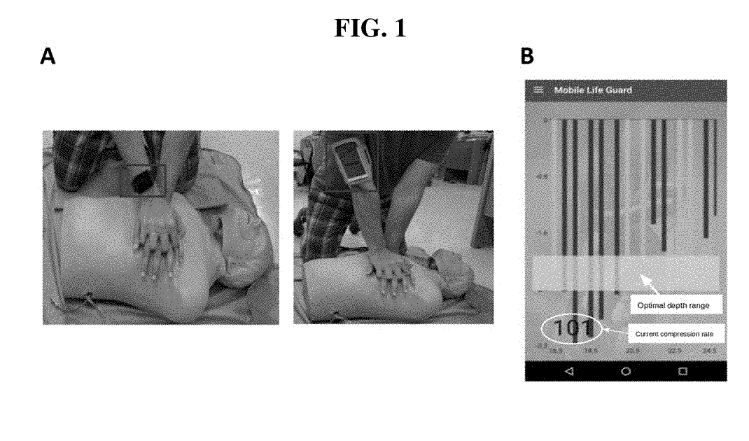

Preferred embodiments include a software program developed for smart-phones and smart-watches. The smart-watch is preferably worn at the wrist while the smart phone was placed in an arm strap around the bicep. FIG. 1A shows preferred placement of the smart phone or watch. The watch is preferably worn at the base of the wrist and the phone is preferably placed in a wearable strap around the bicep. The measurement devices communicate with displays that integrate the collected metrics with real-time auditory and visual feedback for the user. FIG. 1B shows an exemplary feedback screen. The visual feedback shown in FIG. 1B consists of a real-time view of compressions with a marker for the optimal depth range (“target” zone between 2-2.4 inches) and color indications for compressions that meet this depth or compressions that are either too deep or too shallow. Compression rates are displayed visually in addition to audio prompts to increase or decrease rate to a goal of 100-120 compressions per minute.

Based on prior work, the application software uses accelerometers present in these devices to collect quantitative metrics (compression depth and rate) in order to assess the quality of CPR sessions. Parameters were designed to be compliant with American Heart Association guidelines on CPR metrics. In preferred embodiments, a 24×17 cm (9.4×6.6 inch) computer tablet is used to display compression depths with beat-by-beat display of each chest compression. A target depth of 51-61 mm (2-2.4 inches) may be shaded to be easily visible. Compressions may be colored green if they meet the target depth and red if they are too shallow or too deep. CPR rate is preferably shown visually on the tablet and the user is also provided with audio prompts to speed up if the rate falls below 100 compressions per minute or to slow down if above 120 compressions per minute as well as prompts to increase or decrease depth of compressions.

Preferred embodiments of the present disclosure include wearable mobile device technology in facilitating high-quality CPR. Both smart-watch and smart-phone derived metrics are highly accurate in measuring compression rate and both devices show similar degrees of accuracy when measuring compression depth (less than 5 mm). Audio and visual feedback prompts from both devices are timely and appropriate and result in improvement in CPR quality.

As smart-watches and smart-phones become ubiquitous, the potential scalability of medical technology and cost effectiveness of mobile applications improves. A recent effort in King County, Wash. to notify trained bystanders by cell-phone notification to the site of a cardiac arrest resulted in nearly 70% bystander CPR rates with a 54% 5-year survival for ventricular fibrillation arrest. Efforts to empower bystanders as well as all levels of healthcare workers in developed and developing countries could lead to the development of a wide network of well-equipped first responders.

The present mobile device application guided CPR accurately measures compression depth and rate in accordance with resuscitation guidelines. Tracking of rate is highly accurate and there is less than 5 mm of error on average in measuring compression depth.

Preferred embodiments of the present mobile device application include algorithms for (1) collecting the and calculating the depth, rate, and recoil by watch or phone and communicating to a remote device, (2) audio feedback by the phone or watch for an efficient and high quality CPR, (3) transmitting the depth, rate and recoil wirelessly to another device, (4) display of rate, depth and recoil on a remote device, where the display includes insufficient depth, rate and recoil using histograms of different colors, (5) a computer remotely monitoring of CPR sessions for multiple devices (e.g., in a CPR class of 20 or CPR class of 200 with everyone wearing the watch or phone), (6) displaying the visual display in multiple locations (physician, hospital, and 9-1-1 center), and/or (7) calibrating the depth, rate and recoil using a video during CPR. Pixels are extracted from the video and the depth, rate and recoil are calculated. These measurements are used for calibrating (validating) the measurements made by the accelerometer in the phone/watch. The accuracy and resolution of these measurements (sensitivity and specificity) can be calculated.

In preferred embodiments, the mobile device application tracks the depth and rate of the CPR being administered and provides audio feedback cues. Table 1 below shows how the depth and rate may be classified into different ranges.

TABLE 1

| RANGE | DEPTH | RATE |
|---|---|---|
| VERY LOW | 0.8 to 1.2 | 0 to 80 |
| LOW | 1.2 to 1.9 | 80 to 100 |
| TARGET | 1.9 to 2.3 | 100 to 120 |
| HIGH | 2.3 to 2.5 | 120 to 140 |
| VERY HIGH | 2.5+ | 140+ |

Table 2 below shows examples of how the mobile device application can detect combinations of ranges for rate and depth and provide a preferred audio feedback cue.

TABLE 2

| Rate | Depth | Alert |
|---|---|---|
| L | L | Compress Faster and Deeper |
| VH | L | Compress more slowly, Compress a little deeper |
| H | L | Slow down and compress slightly deeper |
| TRG | L | Compress a little deeper |
| H | TRG | Slow down a little |
| TRG | TRG | Continue, Release Fully |
| VH | VL | Compress more slowly, Compress deeper |
| H | VL | Slow down a little, compress deeper |
| TRG | VL | Compress deeper |
| TRG | H | Compress less deep |
| H | H | Slow down a bit and compress less deep |
| VH | H | Compress more slowly, compress less deep |

In preferred embodiments, the mobile device software application for CPR assistance has the following functionality: sensor data processing, motion analysis, CPR performance tracking, real-time feedback generation, remote session monitoring, session visualization, and application calibration.

FIG. 2 shows a high-level flow chart for events and steps in the CPR analysis performed by the mobile device software application.

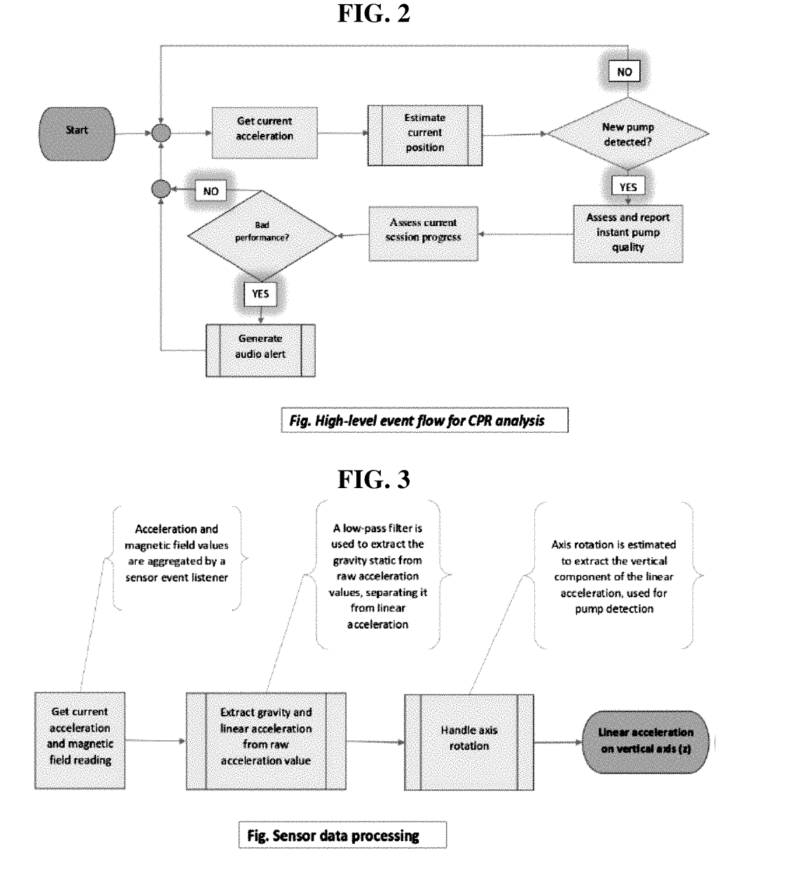

With regard to sensor data processing, to analyze motion, the application uses an acceleration listener registered with a device's sensor manager to estimate how the device is moving. This involves extracting linear acceleration from the generated sensor data and double integrating the acceleration to obtain an estimation of the current position changes. Currently only vertical motion is analyzed for the detection of CPR compressions, so it makes sense to only consider the vertical component of the device's motion. FIG. 3 illustrates procedures involved in obtaining the linear acceleration along the vertical axis.

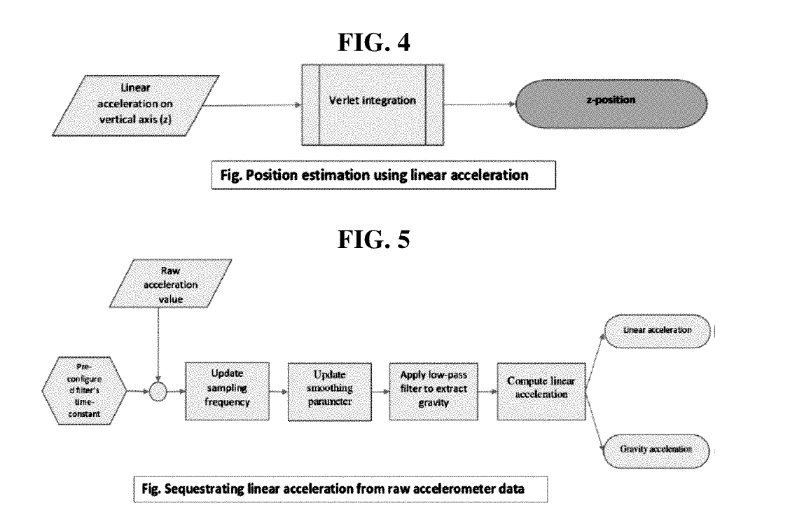

With regard to position estimation, numerical integration is used to estimate position from acceleration. The process involves applying motion equations to the given acceleration data, and post-processing treatment for drift-collection. FIG. 4 shows steps in position estimation using linear acceleration.

With regard to linear acceleration, the raw acceleration obtained from the device's sensors includes the motion-related acceleration with a component caused by gravity and noise deriving from different factors. FIG. 5 illustrates preprocessing steps in extracting an estimation of the linear acceleration from a raw accelerometer reading.

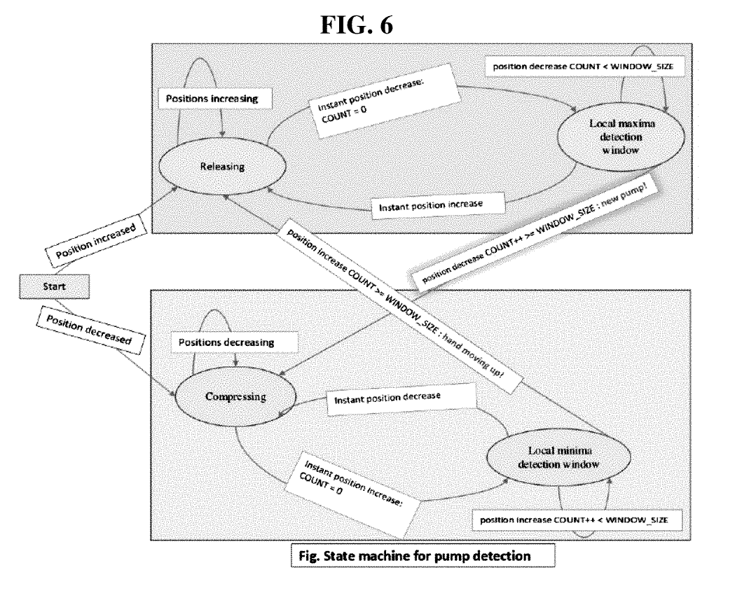

With regard to pump detection, the detection of CPR compressions uses the estimated positions to build motion patterns on which the detection is based. The patterns aid in following the up-down motion of a CPR device and identifying and delimiting the up and down cycles using a real-time search for maxima and minima in a given position stream, as illustrated by the state machine in FIG. 6.

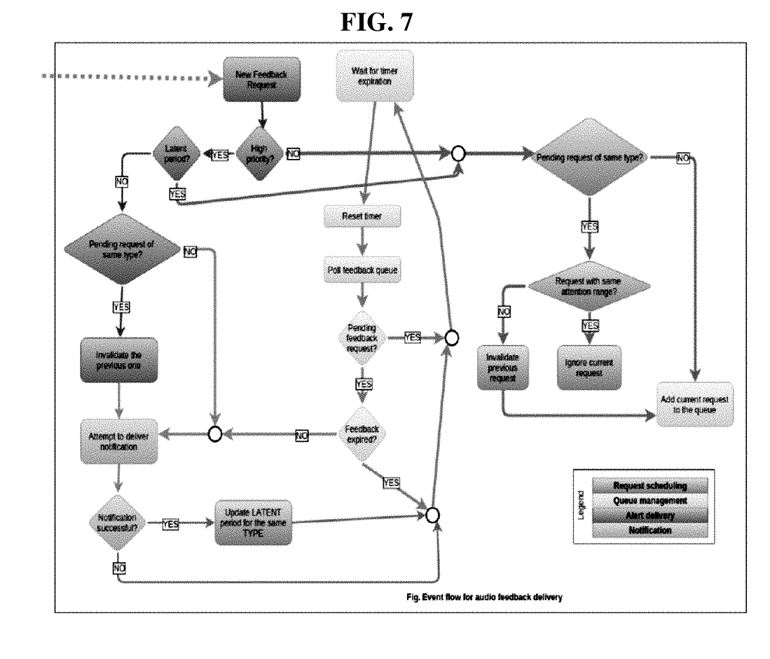

With regard to audio feedback, a CPR performance tracking module uses the information in the reported pumps to give feedback to the user in order to help them improve their performance. The feedback consists of a set of prompts generated when the user's attention is required. The generated prompts are tagged with priorities suggesting how critical their deliveries are, which affects how fast they must be delivered and their relevance at a certain time after they are scheduled. Their scheduling consists of a queue polled regularly and an expiration based on how critical a prompt is. FIG. 7 summarizes how the prompts are generated and how they are delivered.

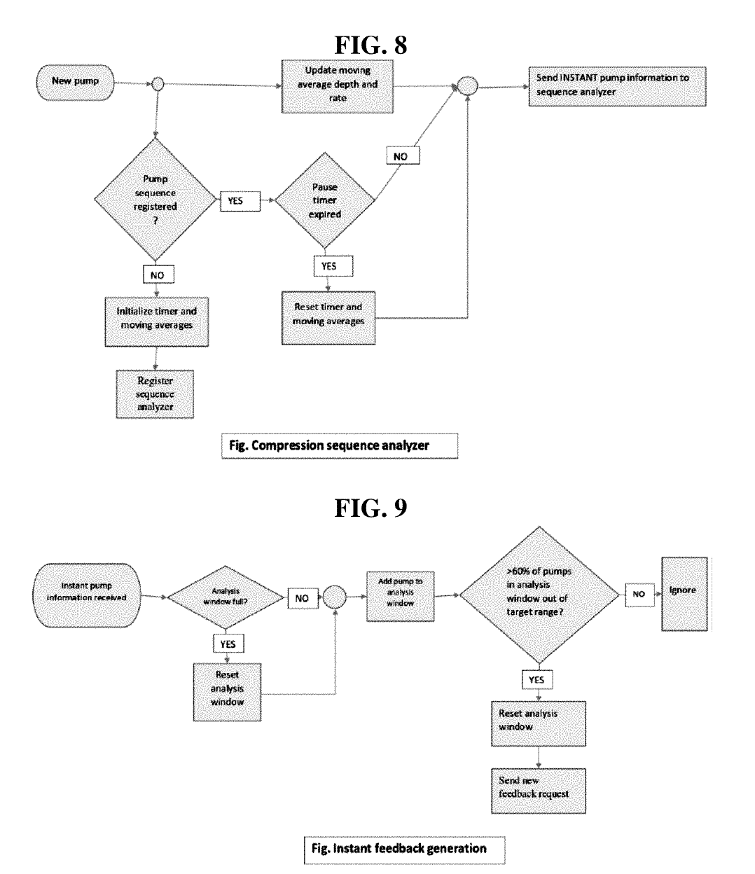

With regard to compression sequence analysis and feedback generation, the feedback generation framework uses the output of a pump sequence analyzer that keeps a moving average of compression rates and depths. The analyzer feeds the framework with instant pump notifications as well as scheduled average updates. The user's performance is deducted from the analyzer's output, which the feedback generation framework uses to decide whether the user's attention is required (when the performance is not as good as needed) or not (when the performance is good enough). FIG. 8 illustrates steps in the sequence analyzer, and FIG. 9 shows how feedback requests are triggered in the feedback generation framework.

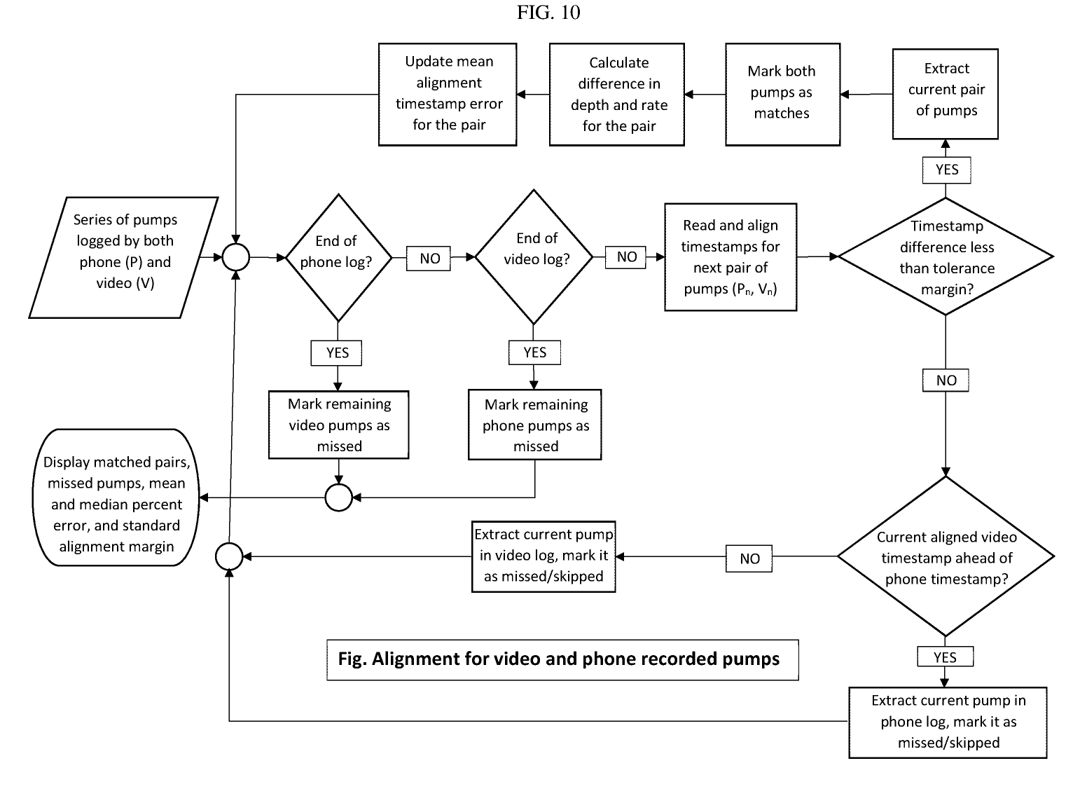

With regard to calibration of video, to measure the accuracy of the application's results, a video-based tracking is used to record the same session and compare the application's results to those from the video. A session video gets processed in a motion tracking software (Adobe After Effects, for example) to extract positions of an attached tracker, from which pump information gets extracted and compared to the reports from the mobile application. FIG. 10 illustrates the process, which mainly consists of a local search for matches between pumps in both the video and the application's logs. This results in a pump-by-pump matching based on timestamp alignment, from which the accuracy of the application (in terms of compression depth and rate) is calculated in comparison to the video results.

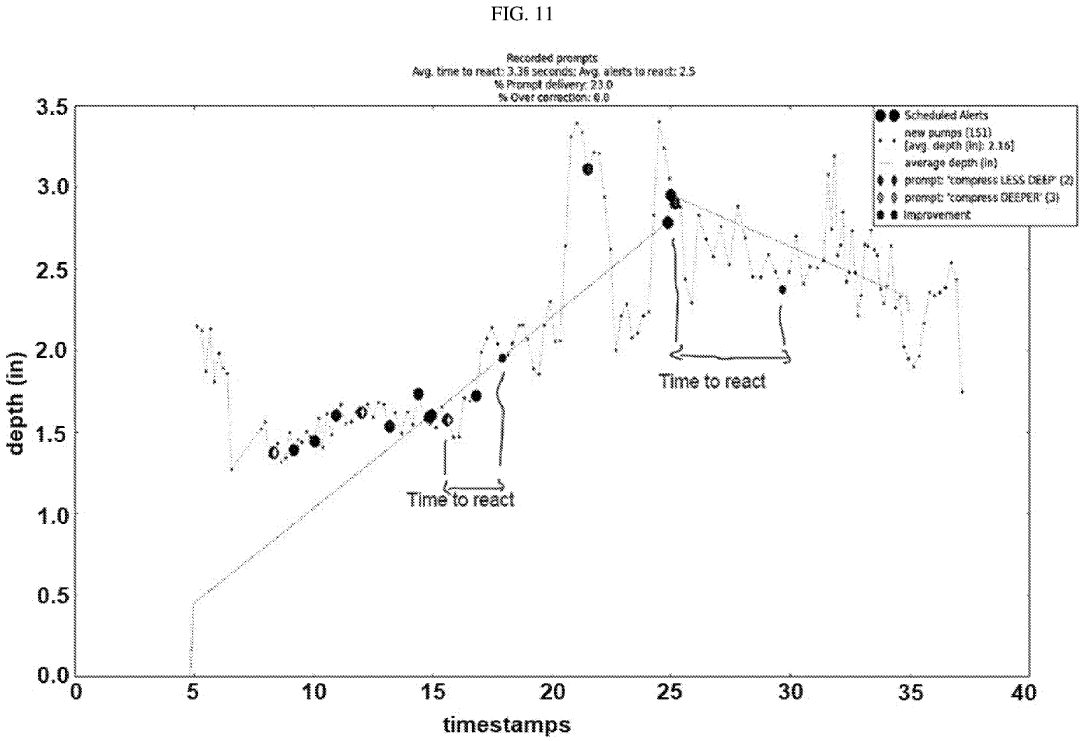

With regard to post-session analysis of generated feedback, the feedback analysis plot visualizes a timeline for the generation of feedback requests and the actual delivery of prompts during a CPR session, as well as the progression of the session and the relevance of the delivered prompts based on the visualized context. This is illustrated in FIG. 11.

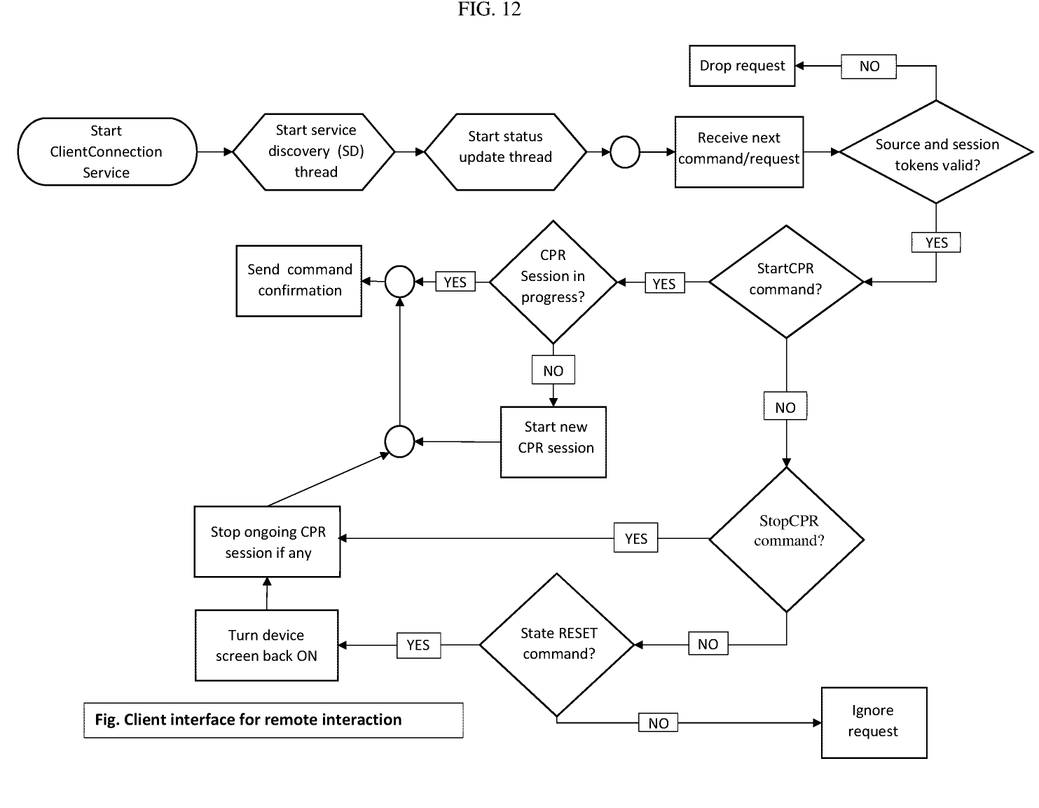

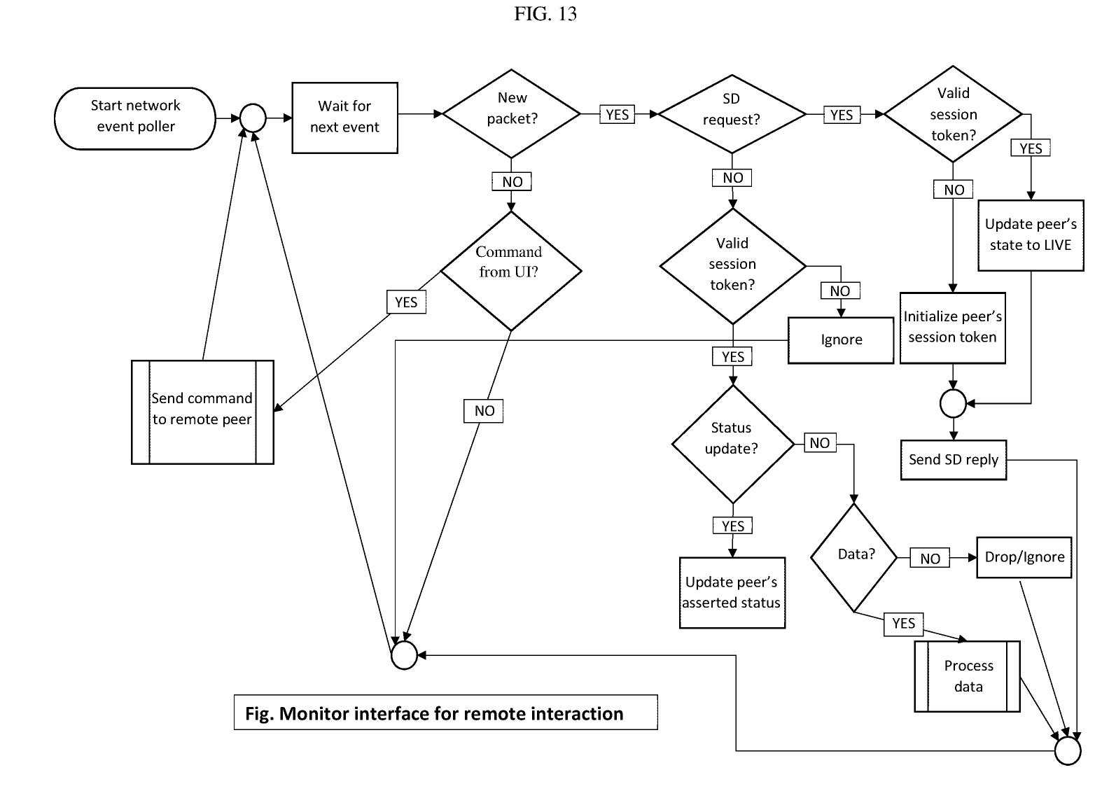

With regard to remote interaction between CPR devices, the application provides a peering interface allowing the application on a device to be controlled from a remote monitor. This helps visualizing a session progress when the CPR used for motion analysis is for example tied to the arm. It also helps monitoring more than one device from a central monitor, which may be needed during training. FIG. 12 summarizes the interfaces on the CPR device (client) and FIG. 13 summarizes the interfaces on the monitor.

### Example 1. Calibration and Analysis

A video-based analysis was used to calibrate the mobile application's motion detection engine. The video-based calibration consisted of recording CPR sessions as the application monitored depth and compression rates after which measured parameters from both the mobile application and video were compared. A motion analysis software was used to track the motion of the hands during the CPR sessions from which compression data (depth, rate, recoil) were calculated. The mobile application results were compared to the results from video motion capture analysis to calibrate parameters in the mobile application. Calibration was also validated against a commercially available manikin CPR feedback system (RQI, Laerdl) which uses a pressure sensor embedded in a manikin's chest to determine depth and frequency of compressions.

Experiments in validation studies focused on evaluating two main goals: the performance of the mobile smart-watch and smart-phone CPR assist application, and the effectiveness of the real-time device feedback on CPR performance. The performance of the application was defined as the accuracy of compression depth and rate measurement as compared to both a motion tracking software and to the RQI manikin. The timeliness and relevance of prompts generated by the application during CPR, and the perceived user reaction were used to judge the effectiveness of the real-time feedback. Each compression during a CPR session was analyzed beat-by-beat for compression rate and depth. A prompt was deemed relevant and timely if it was detected at time when rate, depth or recoil was inappropriate with resultant in improvement in CPR quality within the proceeding 2-3 compressions.

Participants for this study consisted of mostly of intensive care nurses (57%) and other healthcare professionals (MDs, physical therapists, clinical research assistants). Majority of subjects were between ages 26-35 (51%), 43% older than 35, with the rest younger than 26 (6%). The majority of subjects were up to date on CPR qualifications with 78% reporting CPR re-training at least once every 2 years, and 58% who refreshed their CPR skills at least quarterly over the past year.

Over a period of 7 weeks, 50 participants were asked to perform 3 CPR sessions each on a Laerdal Medical RQI manikin practice station while wearing both the smart-watch and smart-phone in the following manner: in the first session the participant performed CPR on the manikin blinded without any feedback, in the second session auditory and visual feedback was given in real-time to the participant using the smart-watch only and in the third session, CPR feedback was given from the smart-phone only. Each CPR session was approximately thirty seconds in duration. During each session, voice prompts from the RQI manikin were silenced and video displays hidden from the participants. When the watch and phone applications were used (second and third sessions), real-time visual session progress was displayed on a computer tablet placed in front of the participant along with audio feedback prompts generated from either mobile device. Data was collected and analyzed from each device (RQI, smart-watch, smart-phone) for all 3 sessions, and participants were given an exit survey at the end.

Compression rate and depth measurements from the RQI manikin were considered to be gold standard for device application testing. Between devices comparison is presented visually below as Bland-Altman plots and statistically using Pearson's correlation and typical error calculation.

### Compression Depth Accuracy

Both smart-watch and smart-phone devices were tested and initially validated using video motion capture software to measure depth. Both devices were highly accurate (Pearson R=0.91) and had average typical error of 2.9 mm (95% CI 2.1-4.7 mm) for compression depth. Fifty subjects then underwent three CPR sessions of 30 second each (blinded with RQI prompts off, smart-watch only feedback, smart-phone only feedback) as described in the methods. The average compression depth measured across 150 unique sessions by the RQI manikin (51.4 mm±5.4 mm), smart-watch (52.0 mm±7.5 mm and smart-phone (52.1 mm±6.5 mm) were similar. There was a moderately strong relationship between measurements from the CPR assist mobile application both on smart-phone (Pearson R=0.61) or watch (Pearson R=0.5) and manikin. Both devices were accurate compared to the RQI manikin over a range of compression depths.

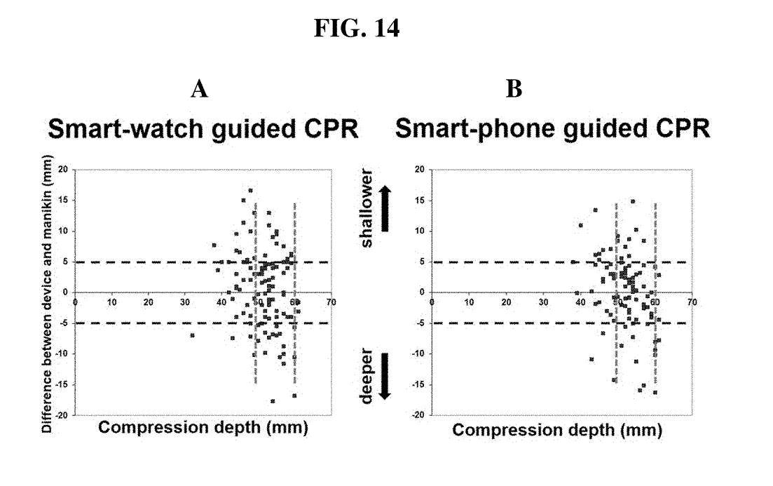

FIG. 14 shows Bland-Altman plots comparing compression depth between smart-watch (A) and smart-phone (B) and calibrated manikin. Each point represents the average obtained from an individual session with dashed lines representing depth variation of +/−5 mm compared to manikin. Points above the dashed line are sessions where the mobile devices under estimated depth >5 mm (compressions shallower than 5 mm); points below are sessions with depths that are deeper than 5 mm. The vertical green dotted lines represent the target compression depth of between 50-60 mm.

The average typical error between the manikin and either smart-phone (4.6 mm; 95% CI 4.1-5.3 mm) or smart-watch (4.3 mm; 3.8-5.0 mm) was less than 5 mm of compression depth for both devices. Approximately 5% of sessions using the smart-watch and 7% of smart-phone resulted in “shallower” compression error compared to the RQI manikin of more than 10 mm (i.e. mobile device reported compression depths that were 10 mm higher than “true” depth). Conversely, 6% of smart-watch and 4% of smart phone sessions reported compression depth error “deeper” than 10 mm compared to the RQI manikin system. Of all sessions, 2% were below the lower compression depth limit of 50 mm and 2% were above the upper compression depth limit of 60 mm.

The preferable mean depth of compression seen herein was approximately 51 mm across all devices and only 4% of actual sessions were above or below the guideline depth recommendation of 50-60 mm. The reason for high adherence to depth recommendations are not clear but could be due to the competency of the test group with slightly more than half reporting they had undergone quarterly CPR refresher training. Alternatively, visual depiction of each compression on a large computer tablet with clearly defined and highlighted depth targets may have also played a role. In addition, audio prompts were minimized as previous studies have suggested audio prompts may have limited utility in improving CPR quality.

### Compression Rate Accuracy

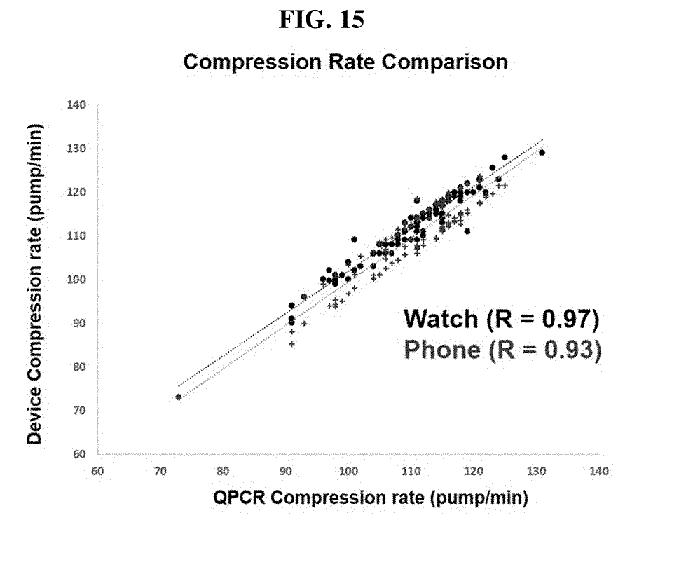

Compression rates measured by both mobile devices were highly accurate compared to the manikin system. FIG. 15 shows a comparison of compression rate between mobile devices and QCPR manikin. Compression rates calculated from smart-watch are shown in black circles and red crosses for smart-phone. Both mobile devices were very accurate with respect to measuring CPR compression rate. Compression rates correlated well across a range of compression frequencies (R=0.97 smart-watch; R=0.93 smart-phone).

### Feedback Accuracy

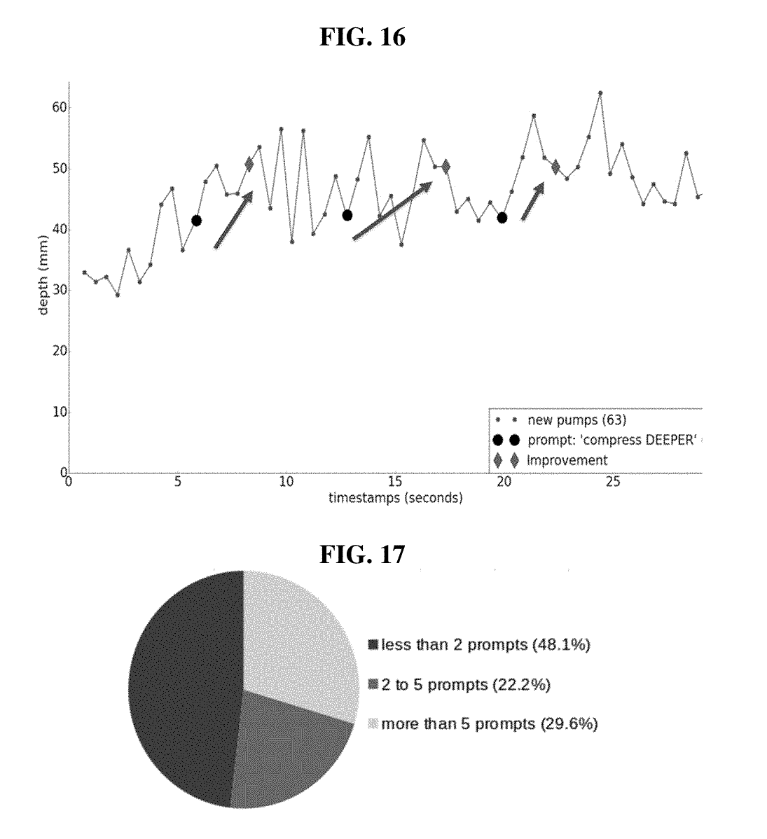

To evaluate the relevance of device feedback prompts, beat by beat compression data from all sessions were analyzed. A feedback prompt was defined as relevant if it identified rate or depth metrics outside the defined parameter range (100-120 compressions/minute for rate; 50-60 mm for depth). If a subject corrected the deficiency within the subsequent 2-3 compressions, it was categorized as a successful prompt. FIG. 16 shows an example of CPR application feedback prompts and subsequent CPR improvement. Each small dot represents a single compression. Large dots represent audio prompts given to user, in this case to “compress deeper.” Diamonds show resultant improvement in CPR compression depth (shown with arrows).

Per session, prompts were found to be successful 98% of the time if compression rate was incorrect and 99% if compression depth was incorrect. On average, subjects received 2 prompts during each 30 second CPR session in approximately 50% of sessions and more than 5 prompts in 30% of testing sessions. FIG. 17 shows the number of prompts received. The mean observed time to react was 1.7 seconds for the rate prompts, and 1.1 seconds for the depth prompts.

### Comfort

All subjects reported feeling feedback from either mobile device was appropriate with regards to prompt relevance and frequency of prompts. The results are shown in Table 3 below. The majority felt ergonomically comfortable with the smart-watch but fewer felt comfortable wearing the smart-phone, particularly those with no formal CPR training (30%).

TABLE 3

| | | Comfortable | Comfortable | Feedback |
|---|---|---|---|---|
| Training | Group Size | with watch | with phone | appropriate |
| frequency | (n) | (%) | (%) | (%) |
| Every 3 months | 29 | 97 | 93 | 100 |
| Every 6 to 12 | 7 | 100 | 43 | 100 |
| months | | | | |
| Every 2 years | 3 | 100 | 100 | 100 |
| No training | 11 | 100 | 30 | 100 |

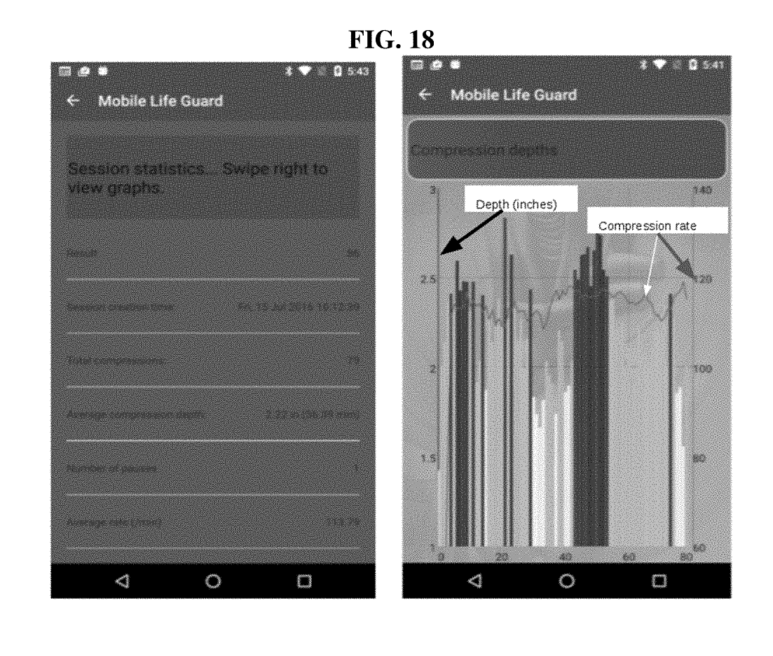

The application also provides the ability to review and debrief after a CPR event, as shown in the screen representations in FIG. 18, which can further enhance training, either instructor led or self-directed. This session review feature allows tracking of user performance by reloading previous sessions.

### Example 2. Embodiment of Application

A mobile application was developed for assisting users in performing CPR. Details for use and exemplary screen shots are provided in this example. Preferably, documentation should be provided to the user which covers the instructions to perform the CPR, Use cases of the application, that is scenarios in which the application can be used and requirements for the whole system to work together.

Two independent applications are provided, and they can be used in following two scenarios:

If the user has an android smart-watch connected to a smart-phone. (Smart-watch App); or
If the user has two android smart-phones. (Arm-band App).

Instructions for CPR should be provided, preferably with diagrams. Users should be informed to:

Keep your elbows straight while performing the CPR.
Align your shoulder directly above the chest of the victim
Make sure the smart-watch or arm-band is tight fitted on your wrist or arm.
Refer figures for the correct posture while performing CPR

Users should also be informed:

Don't perform CPR with sudden jerks, it should be a smooth consistent motion.
Don't bend your elbows while performing CPR

Preferable instructions for installation and launch of the application are as follows:

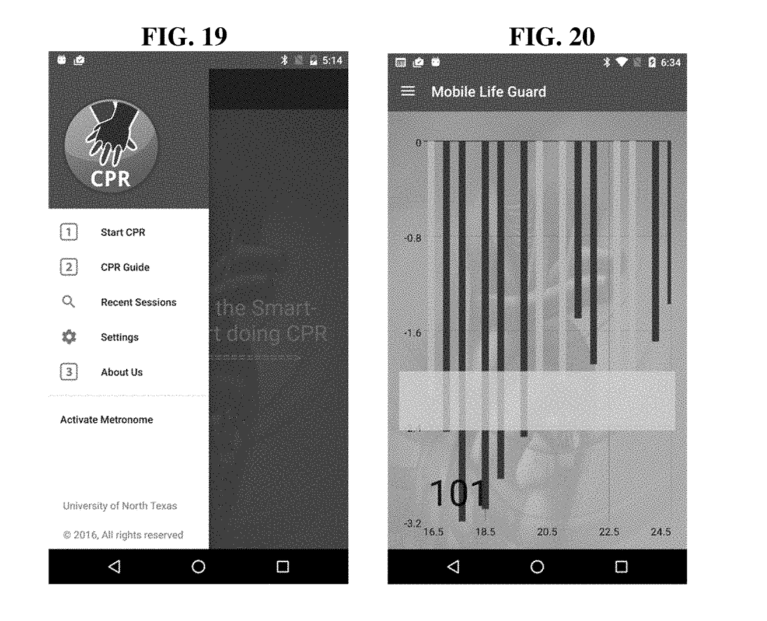

FIG. 19 shows a navigation screen of this embodiment of the mobile device application. FIG. 20 shows a screen shot of how visual feedback is provided to the user. The user will get the visual feedback on the screen in the form of a histogram. It is recommended to use a larger device such as tablet as a display device so as to see the visual feedback clearly from a certain distance. The inverted bars shown in FIG. 20 are the pumps, which will be added to the view while user performs CPR. Colored bars, such as green bars, indicate the correct depth of compressions while other colored bars, such as red bars, indicate either the depth is low or high that the desired range. A colored band indicates the desired range of 1.8 to 2.4 inches. The rate of compressions is also shown on the screen as the user proceeds, with the recommendation to keep it in between 100 to 120 compressions/min.

Additionally, the user will get the audio feedback alerts like ‘Compress Faster’, ‘Compress Deeper’, Compress Slower, etc. The user should take actions according to the alerts in order to improve the effectiveness of CPR being performed.

An exemplary application for an arm-band requires two devices, one being the client device which will fit into the arm band and the other being the monitor device which will be used to get the audio-visual feedback. The application for Arm-band should be installed in both the client and monitor devices.

Three application launchers will occur after the installation of application, such as ‘Mobile Life Guard’, ‘Android CPR Service’ and ‘Remote CPR Monitor.’

For connectivity of Client device and monitor there are two available options, WIFI and WIFI Direct. If using the WIFI, both the devices should be connected to the same WIFI network. The ‘Android CPR Service’ should be launched on the client device and the WIFI option selected. Check if the service has already started listening, if not click on ‘Start Listening’ button. The connection status is checked on the screen. Next, launch the Remote CPR Monitor application on the monitor device and select WIFI as the connectivity option. A dashboard is seen showing the list of devices available in the network. The device which is being used in an Arm-band should be clicked, to show two buttons. The button ‘Start new CPR session’ should be clicked, which will launch the application on the arm-band device. The button ‘Display progress’ should then be clicked, followed by the start of compressions. The user will get the visual and audio feedback on the monitor device.

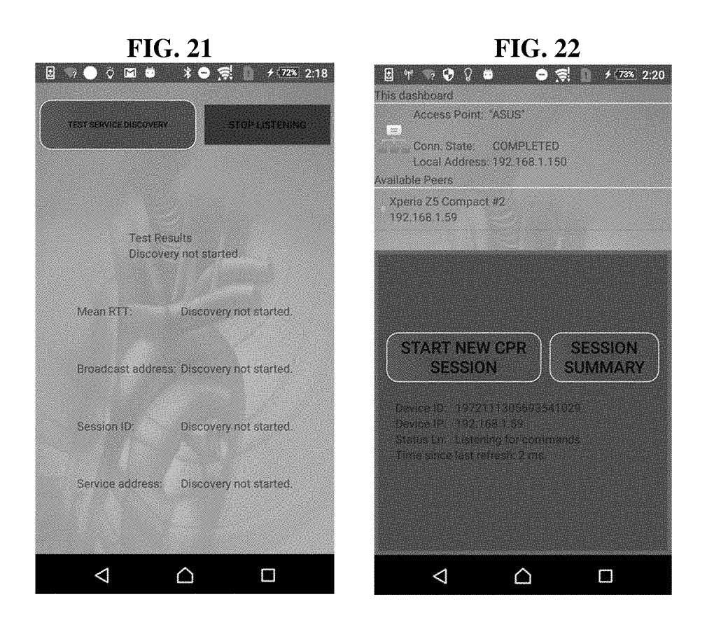

FIG. 21 shows a screen shot from an exemplary ‘Android CPR Service’ application. FIG. 22 shows a screen shot from a ‘Remote CPR Monitor” dashboard.

The user can use WIFI Direct if there is no WIFI network available. WIFI Direct can be configured from the WIFI settings of the android phone and connected to each other, or when user clicks on ‘WIFI Direct’ Infrastructure of the application, it will send invitation to connect to other network devices.

All other steps after connection will be the same. Use of WIFI is recommended instead of WIFI Direct as it is found to be working better and improvements are being done on the WIFI Direct module.

The following modules may be included in the applications.

CPR Guide: This module contains the instructions to perform CPR most effectively. It contains the information according to the latest AHA Guidelines and how to effectively use this application to perform CPR.

Recent Sessions: When CPR is performed the session data is saved on the phone for further analysis. This session data can be reviewed in this module; it is sorted according to the time when the CPR is performed. Any session can be selected to review and analyze it, this review can further help user to improve CPR so that it is most effective. It contains three tabs, Session summary, Pump Review and position review as shown in the screen shots.

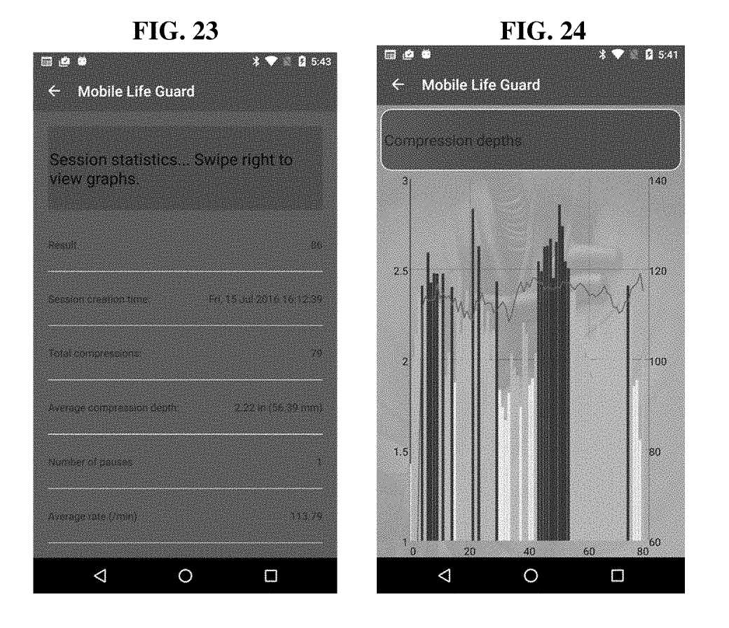

Session Review, shown in a screen shot in FIG. 23, is helpful to know the overall quality of CPR performed in that session. The score is the percentage that indicates the good quality CPR. Other parameters are there which indicated the average depth, average rate of compressions and number of pauses taken while performing the compressions.

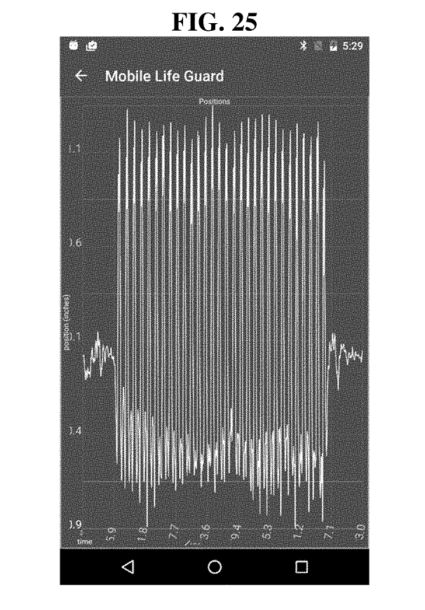

Pump Review, shown in a screen shot in FIG. 24, shows pump by pump depth and rate. The scale on left side shows the depth in inches of the compressions while the scale on right shows the rate of compressions, i.e. the compressions performed per minute.

Position review, shown in a screen shot in FIG. 25, shows the position data calculated from the acceleration of the device, if logging is enabled then device will log the position data and it will be available to view otherwise not. The position data is useful for analyses of developers if something went wrong in the session or if the application seems to behave abnormally.

Settings: This module is to configure the parameters used by the system, the changes made in the settings persist between the sessions. The settings such as audio on/off, the interval of audio feedback, metronome on/off, frequency of metronome, calibration, etc. can be changed from this module.

Activate Metronome: This works as a toggle switch; Metronome sound starts after clicking on it with the frequency specified in the settings.

This application can be used for training individuals for performing good quality CPR. The sessions can be reviewed at the end to track the individual's performance. It can be used in hospitals for RQI (Resuscitation Quality Improvement). It can be used while performing CPR on victims so that the quality of CPR being delivered can be monitored.

### REFERENCES CITED

The following documents and publications are hereby incorporated by reference.

### Non-Patent Publications

Christenson J, Andrusiek D, Everson-Stewart S, et al. Chest compression fraction determines survival in patients with out-of-hospital ventricular fibrillation. Circulation 2009; 120:1241-7.
Neumar R W, Shuster M, Callaway C W, et al. Part 1: Executive Summary: 2015 American Heart Association Guidelines Update for Cardiopulmonary Resuscitation and Emergency Cardiovascular Care. Circulation 2015; 132:S315-67.
Wallace S K, Abella B S, Becker L B. Quantifying the effect of cardiopulmonary resuscitation quality on cardiac arrest outcome: a systematic review and meta-analysis. Circ Cardiovasc Qual Outcomes 2013; 6:148-56.
Cheng A, Brown L L, Duff J P, et al. Improving cardiopulmonary resuscitation with a CPR feedback device and refresher simulations (CPR CARES Study): a randomized clinical trial. JAMA Pediatr 2015; 169:137-44.
Smith K K, Gilcreast D, Pierce K. Evaluation of staffs retention of ACLS and BLS skills. Resuscitation 2008; 78:59-65.
Meaney P A, Bobrow B J, Mancini M E, et al. Cardiopulmonary resuscitation quality: [corrected] improving cardiac resuscitation outcomes both inside and outside the hospital: a consensus statement from the American Heart Association. Circulation 2013; 128:417-35.
Cho G C, Sohn Y D, Kang K H, et al. The effect of basic life support education on laypersons' willingness in performing bystander hands only cardiopulmonary resuscitation. Resuscitation 2010; 81:691-4.
Couper K, Kimani P K, Abella B S, et al. The System-Wide Effect of Real-Time Audiovisual Feedback and Postevent Debriefing for In-Hospital Cardiac Arrest: The Cardiopulmonary Resuscitation Quality Improvement Initiative. Crit Care Med 2015; 43:2321-31.
Abella B S, Edelson D P, Kim S, et al. CPR quality improvement during in-hospital cardiac arrest using a real-time audiovisual feedback system. Resuscitation 2007; 73:54-61.
Kramer-Johansen J, Myklebust H, Wik L, et al. Quality of out-of-hospital cardiopulmonary resuscitation with real time automated feedback: a prospective interventional study. Resuscitation 2006; 71:283-92.
Gupta N D, V; Dantu, R. Effective CPR Procedure With Real Time Evaluation and Feedback Using Smartphones. IEEE Journal of Translational Engineering in Health and Medicine 2014; 2.
Mozaffarian D, Benjamin E J, Go A S, et al. Heart disease and stroke statistics—2015 update: a report from the American Heart Association. Circulation 2015; 131:e29-322.
Vahedian-Azimi A, Hajiesmaeili M, Amirsavadkouhi A, et al. Effect of the Cardio First Angel device on CPR indices: a randomized controlled clinical trial. Crit Care 2016; 20:147.
Hostler D, Everson-Stewart S, Rea T D, et al. Effect of real-time feedback during cardiopulmonary resuscitation outside hospital: prospective, cluster-randomised trial. BMJ 2011; 342:d512.
Vadeboncoeur T, Stolz U, Panchal A, et al. Chest compression depth and survival in out-of-hospital cardiac arrest. Resuscitation 2014; 85:182-8.
Bohn A, Weber T P, Wecker S, et al. The addition of voice prompts to audiovisual feedback and debriefing does not modify CPR quality or outcomes in out of hospital cardiac arrest—a prospective, randomized trial. Resuscitation 2011; 82:257-62.
Hong J Y, Oh J H, Kim C W, Lee D H. Hand injuries caused by feedback device usage during cardiopulmonary resuscitation training. Resuscitation 2016; 107:e3-4.
Ozdalga E, Ozdalga A, Ahuja N. The smartphone in medicine: a review of current and potential use among physicians and students. J Med Internet Res 2012; 14:e128.

What is claimed is:

1. A method for performing CPR with assistance from a mobile device application, namely:
installing a mobile device software application on at least a first mobile device and a second mobile device, wherein at least the first mobile device is equipped with an accelerometer, and wherein the mobile device software application monitors and provides feedback on the performance of CPR;
affixing the first mobile device on a user;
activating the mobile device software;
performing CPR compressions, wherein the mobile device software application collects data obtained by the accelerometer and records chest compression depth, chest compression rate, and chest compression recoil while the user performs CPR;
displaying data on the second mobile device relating to recorded chest compression depth, recorded chest compression rate, recorded chest compression recoil, target chest compression rate, target chest compression depth, and target chest compression recoil; and
adjusting CPR compressions to approach the target chest compression depth, the target chest compression rate, and the target chest compression recoil.

2. The method of claim 1, further comprising providing audio instructions to the user regarding the adjusting of CPR compressions.

3. The method of claim 1, further comprising providing audio instructions to the user from the first mobile device or the second mobile device regarding the adjusting of CPR compressions.

4. The method of claim 1, further comprising the step of displaying a summary of the recorded chest compression depth, recorded chest compression rate, and recorded chest compression recoil following completion of CPR.

5. The method of claim 1, further comprising the step of reviewing the recorded chest compression depth, recorded chest compression rate, and recorded chest compression following completion of the CPR.

6. The method of claim 1, wherein at least one of the first mobile device and the second mobile device is a watch or a phone.

7. The method of claim 1, further comprising the step of calibrating the mobile device software application during a calibration CPR session, wherein the step of calibrating comprises using the mobile device software application during the calibration CPR session, recording a video of the calibration CPR session, using motion analysis to track hand position on the video during the calibration CPR session, using a CPR feedback system to determine depth, frequency, and recoil of compressions, and comparing results to calibrate the mobile device software application.

8. A system for assisting in performance of CPR, comprising:
at least one first mobile device, wherein the first mobile device is equipped with an accelerometer, and wherein the first mobile device can be affixed to the wrist of a CPR administrator;
a second mobile device; and
a mobile device software application installed on the first mobile device and the second mobile device for monitoring and providing feedback on the performance of CPR, wherein the mobile device software application collects data obtained by the accelerometer and records chest compression depth, chest compression rate, and chest compression recoil while the CPR administrator performs CPR, and wherein the mobile device software displays data on the second mobile device relating to recorded chest compression depth, recorded chest compression rate, recorded chest compression recoil, target chest compression rate, target chest compression depth, and target chest compression recoil.

9. The system of claim 8, wherein the mobile device software application provides audio instructions regarding adjusting CPR compressions.

10. The system of claim 8, wherein the mobile device software allows a user to review the recorded chest compression depth, recorded chest compression rate, and recorded chest compression recoil following completion of CPR.

11. The system of claim 8, wherein the mobile device software displays a summary of the recorded chest compression depth, recorded chest compression rate, and recorded chest compression recoil following completion of CPR.

12. The system of claim 8, wherein at least one of the first mobile device and the second mobile device is a watch or a phone.

13. The system of claim 8, comprising a plurality of first mobile devices, and wherein the second mobile device is located remotely from at least one of the first mobile devices.

14. The system of claim 13, wherein the second mobile device is configured to display data from the plurality of first mobile devices.

15. The system of claim 8, wherein the mobile device software has been calibrated by motion analysis of a video recorded CPR session.
